(19) United States
(12) Patent Application Publication
(10) Pub. No.: US 2014/0167489 A1
(43) Pub. Date: Jun. 19, 2014

(54) INTEGRAL WHEEL RIM FOR WHEELCHAIR

(71) Applicant: KUNSHAN HENRY METAL TECHNOLOGY CO., LTD., Jiangsu (CN)

(72) Inventor: KEE PING THO, JIANGSU (CN)

(73) Assignee: KUNSHAN HENRY METAL TECHNOLOGY CO., LTD., JIANGSU (CN)

(21) Appl. No.: 13/713,163

(22) Filed: Dec. 13, 2012

(51) Int. Cl. A61G 5/02

(52) U.S. Cl. CPC A61G 5/028
USPC 301/6.5

(57) ABSTRACT

An integral wheel rim for a wheelchair includes a wheel rim and a groove is integrally defined in the outer periphery of the wheel rim. A hand rim is located parallel to the wheel rim and integrally formed with the wheel rim. The hand rim has a palm portion on the outer periphery thereof and a finger portion on the inner periphery of the hand rim. A hollow rib is connected between the wheel rim and the hand rim. The hollow rib is composed by an inner wall and an outer wall. A hollow area is defined between the inner and outer walls and communicates with the first and second hollow portions. The outer wall has a handle portion on the outer surface thereof for being grasped by the user's hand. The hollow rib absorbs the impacts from the ground and is reinforced by the thicker thickness.

### FIELD OF THE INVENTION

The present invention relates to an integral wheel rim for a wheelchair, and more particularly, to an integral wheel rim with a hollow rib connected between the handle portion and the wheel rim to reduce the weight and reinforce the strength.

### BACKGROUND OF THE INVENTION

The conventional wheelchair for disable persons generally comprises a frame, a seat, two armrests, two leg rests, two rims, a hand rim for each wheel, a brake unit and a handle. The conventional wheelchair can be driven by electric power or by manual way.

The sizes of the rims generally have 12 inches, 16 inches, 18 inches, 20 inches, 22 inches and 24 inches. For the manual operated wheelchair, the size of the rims is over 24 inches so as to save the effort of the user. For the electric wheelchair, the size of the rims is smaller so that the electric power easily drives the wheelchair and the smaller rims are safe.

There is an hand rim attached to the rim so that the user can grasp the handle portion to move the wheelchair forward or backward. The hand rim is integrally formed with the rim, or is connected to the rim.

Taiwan Utility Model 098204096 discloses a rim with lugs extending laterally therefrom, a tire is engaged with the insides of the lugs and an hand rim connected to the outside of the rim. The hand rim is made by non-metallic material such as rubber or polymer material. A connection portion extends from the inside of the hand rim and has an engaging slot which is engaged with the lugs of the rim.

U.S. Pat. No. 7,303,203 discloses a wheel for a wheelchair with a hand rim device comprised of a heat conducting tubular hand rim and a continuous circumferential elastomeric interface that has a cross-sectional contour comprised of an outwardly extending horizontal member having a proximal end coupled to an outboard side of a wheel rim transitioning into a downwardly depending member terminating to a distal end coupled to an inboard upper portion of the tubular hand rim such that a majority of the tubular hand rim is exposed and devoid of the elastomeric interface. When braking, a user only uses the heat conducting tubular hand rim. When pushing, the user grips across both the tubular hand rim and the contoured elastomeric interface, which deforms to fit the hand, thereby providing improved comfort, frictional coupling, and impact attenuation.

U.S. Pat. No. 7,204,506 discloses a wheel for a wheelchair and has a tire groove and a reinforcement device which has a tube located on the inside of the tire groove. A hand rim is connected to the wheel and a mediate portion connected between the reinforcement device and the tire groove.

The wheels of the wheelchair cannot be too weight and the thickness and size of the connection parts for connection between the wheel rim and the hand rim are limited. The hand rim is co-rotated with the wheel and the user's force is applied to the hand rim and the transferred to the wheel so that the connection parts between the hand rim and the wheel rim have to be strong to bear the torque. Furthermore, the connection parts have to bear the force applied along the tangential direction of the hand rim.

The connection part of the integral hand rim is solid but has thin thickness which cannot increase the force transferring feature and the thin thickness may be deformed when a large torque is applied. When the wheel of the wheelchair receives an impact, the wheel rim may be broken to injure the user. Besides, the solid connection part does not buffer the impact and the user feels discomfort after operating for a period of time.

The present invention intends to provide an integral rim for a wheelchair and the integral rim improves the shortcomings mentioned above.

### SUMMARY OF THE INVENTION

The present invention relates to an integral wheel rim for a wheelchair and comprises a wheel rim and a groove is integrally defined in the outer periphery of the wheel rim and a tire is engaged with the groove. A flange extends inward and radially from the inner periphery of the wheel rim and has a first hollow portion. A hand rim is located parallel to the wheel rim and integrally formed with the wheel rim. The hand rim has a palm portion and a finger portion, wherein the palm portion is located on the outer periphery of the hand rim and the finger portion is located on the inner periphery of the hand rim. The palm portion and the finger portion enclose a second hollow portion. A hollow rib is connected between the wheel rim and the hand rim. The hollow rib is composed by an inner wall and an outer wall. The inner and outer walls is separated from each other. A hollow area is defined between the inner and outer walls and communicates with the first and second hollow portions. The outer wall has a handle portion on the outer surface thereof for being touched by the user's hand. The hollow rib is connected between the hand rim and the wheel rim so as to absorb the impacts from the ground and is reinforced by the thicker thickness.

The primary object of the present invention is to provide an integral wheel rim and a hollow rib is connected between the wheel rim and the hand rim. The thickness of the hollow rib is increased to reinforce the strength.

Another object of the present invention is to provide an integral wheel rim and the hollow rib can absorb the impacts from the ground.

Yet another object of the present invention is to provide an integral wheel rim wherein the hollow rib is composed of the inner wall and the outer wall so as to efficiently transfer force to the wheel rim and reduce the weight.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the wheel rims of the present invention connected to a wheel chair;

FIG. 2 is a perspective view to show the wheel rim of the present invention;

FIG. 3 is a cross sectional view of the wheel rim of the present invention;

FIG. 4 is a cross sectional view of the second embodiment of the wheel rim of the present invention;

FIG. 5 is a cross sectional view of the third embodiment of the wheel rim of the present invention;

FIG. 6 is a perspective view to show the fourth embodiment of the wheel rim of the present invention;

FIG. 7 is a cross sectional view of the fourth embodiment of the wheel rim of the present invention;

FIG. 8 is a perspective view to show the fifth embodiment of the wheel rim of the present invention;

FIG. 9 is a cross sectional view of the fifth embodiment of the wheel rim of the present invention;

FIG. 10 is a perspective view to show the sixth embodiment of the wheel rim of the present invention;

FIG. 11 is a cross sectional view of the sixth embodiment of the wheel rim of the present invention, and

FIG. 12 is a partial perspective view to show the seventh embodiment of the wheel rim of the present invention.

### DETAILED DESCRIPTION OF THE PREFERRED EMBODIMENT

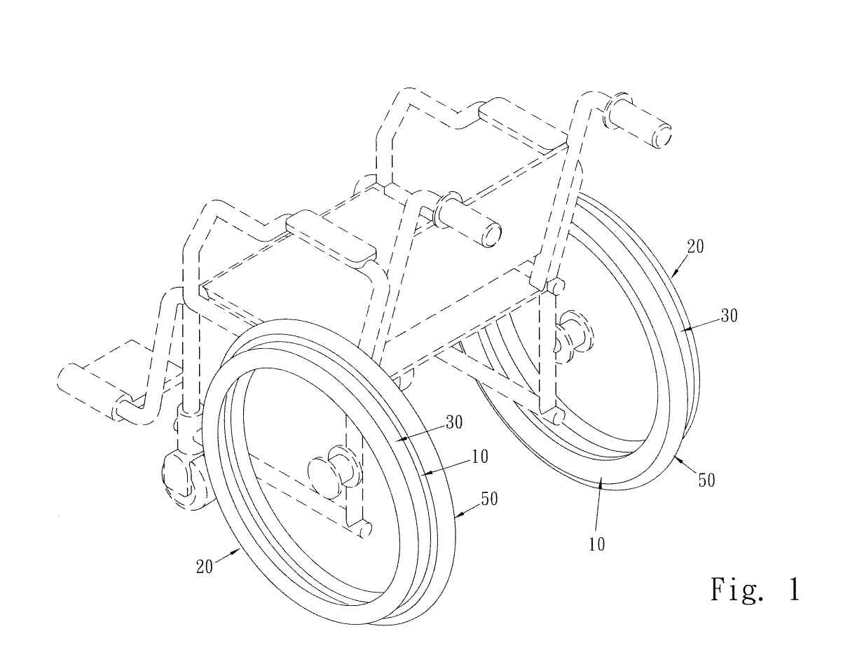

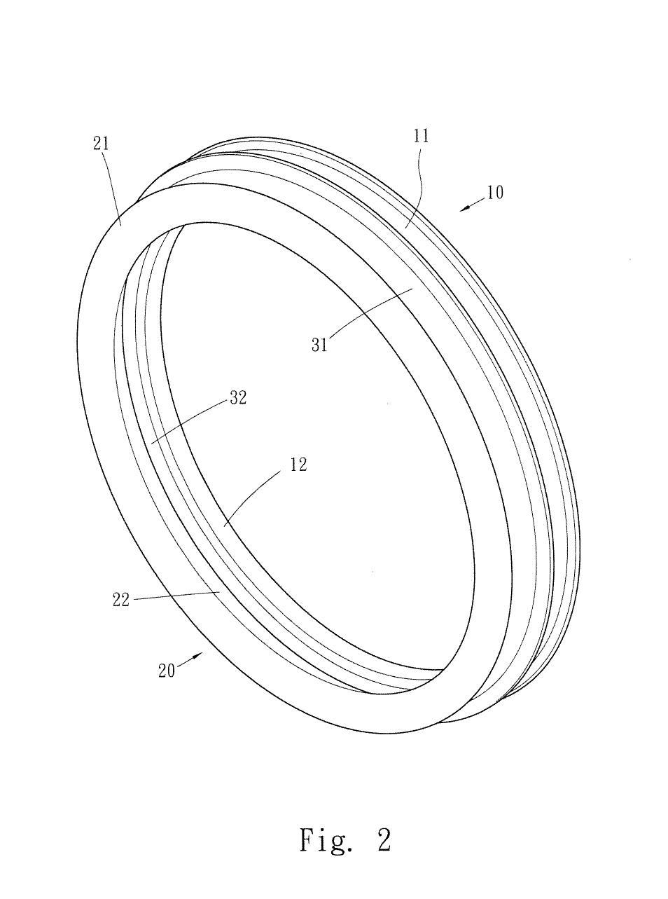

Referring to FIGS. 1 to 3, the wheel rim 10 of the present invention comprises a wheel rim 10 and a hand rim 20 is located parallel to the wheel rim 10. A hollow rib 30 is connected between the wheel rim 10 and the hand rim 20.

The wheel rim 10 is a ring-shaped rim and a groove 11 is integrally defined in the outer periphery of the wheel rim 10. The groove 11 is an open groove and a tire 50 is engaged with the groove 11. A flange 12 extends inward and radially from the inner periphery of the wheel rim 10 and has a first hollow portion 13 such that spokes (not shown) are connected to the inner periphery of the flange 12.

The hand rim 20 is parallel to the wheel rim 10 and integrally formed with the wheel rim 10. The hand rim 20 is a ring-shaped rim and has a palm portion 21 and a finger portion 22. The palm portion 21 is integrally formed on the outer periphery of the hand rim 20 and the finger portion 22 is integrally formed on the inner periphery of the hand rim 20. The palm portion 21 and the finger portion 22 enclose a second hollow portion 23.

The hollow rib 30 is connected between the wheel rim 10 and the hand rim 20. The hollow rib 30 is composed by an outer wall 31 and an inner wall 32. The inner and outer walls 32, 31 are separated from each other at a pre-set distance. A hollow area 33 is defined between the inner and outer walls 32, 31 and two sides of the hollow area 33 communicates with the first and second hollow portions 13, 23 respectively. The outer wall 31 has a handle portion 34 on the outer surface thereof and the handle portion 34 has a curved and recessed surface so as to be grasped or touched by the user's hand.

The hollow rib 30 is connected between the hand rim 20 and the wheel rim 10 so as to absorb impacts from the ground and the hollow rib 30 is reinforced by the thicker thickness which prevents the hollow rib 30 from being formed. The hollow rib 30 also reduces the weight of the wheel rim 10.

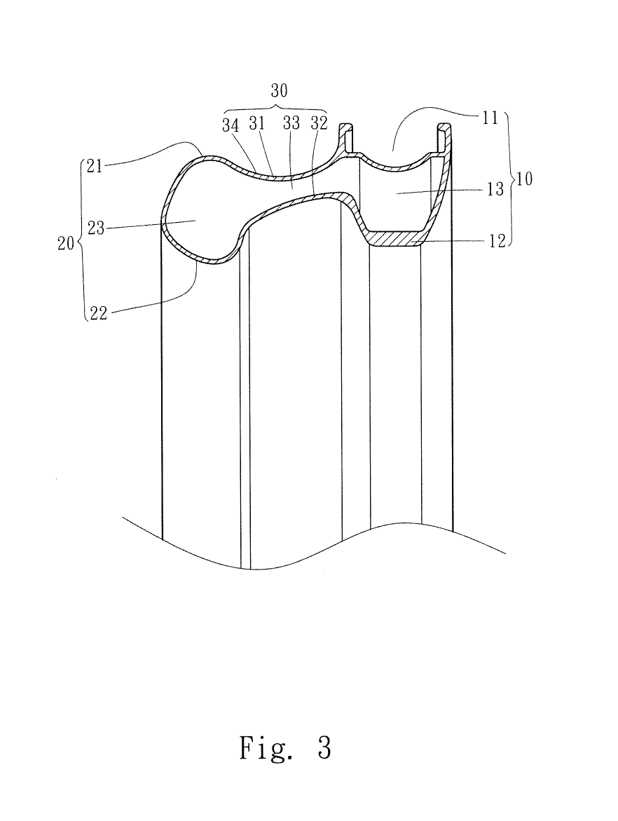

As shown in FIG. 3, the groove 11, the flange 12, the palm portion 21, the finger portion 22 and the inner and outer walls 32, 31 are integral to the wheel rim 10. The two sides of the inner and outer walls 32, 31 are respectively connected to the wheel rim 1 and the hand rim 20. The inner wall 32 is connected between the flange 12 and the palm portion 21, and the outer wall 31 is connected between the flange 12 and the finger portion 22. The hollow area 33 is defined between the inner and outer walls 32, 31. The palm portion 21 and the finger portion 22 defined the second hollow portion 23. The first and second hollow portions 13, 23 and the hollow area 33 are in communication with each other such that when manufacturing the wheel rim 10, the groove 11, the flange 12, the palm portion 21, the finger portion 22 and the inner and outer walls 32, 31 are easily formed.

The groove 11 is defined in the outer wall 31 and the outer wall 31 has the handle portion 34 on the outer surface thereof. When the user holds the hand rim 20, the palm touches the palm portion 21 and the handle portion 34, and the fingers touch the finger portion 22. The sizes and curvatures of the palm portion 21, the handle portion 34 and the finger portion 22 can be adjusted as needed.

The hollow rib 30 is integrally connected between the wheel rim 10 and the hand rim 20 so as to reduce the weight of the wheel rim 10. The distance between the inner and outer walls 32, 31 is increased and the thickness of the hollow rib 30 is increased to reinforce the strength so as to prevent from being broken or deformed.

The first and second hollow portions 13, 33 and the hollow area 33 impede the impacts from the ground to be transferred to the user. This makes the user feel comfortable when compared with the solid wheel rim. The first and second hollow portions 13, 33 and the hollow area 33 also absorb vibration.

The inner and outer walls 32, 31 of the hollow rib 30 splits the push force into two portions which are more efficiently transferred to the wheel rim. The design allows the user to more easily operate the wheel rim 10.

The hollow rib 30 has thicker thickness which reduces the material required and saves manufacturing cost.

The hollow rib 30 reduces the weight of the wheel chair when compared with the solid wheel rim.

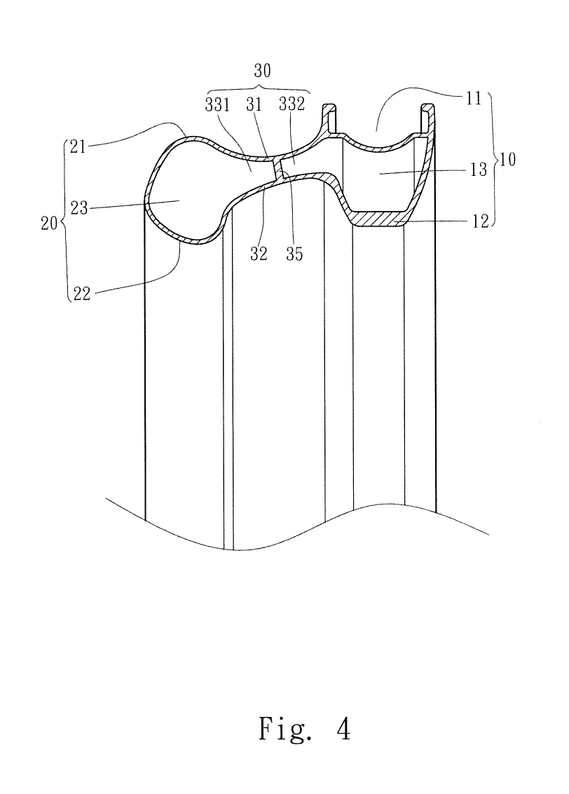

As shown in FIG. 4, the second embodiment of the present invention provides a reinforcement rib 35 is integrally connected between the inner and outer walls 32, 31. The reinforcement rib 35 divides the hollow area 33 into two spaces 331, 332. The reinforcement rib 35 can be made during manufacturing processes.

The reinforcement rib 35 reinforces the strength of the hollow rib 30.

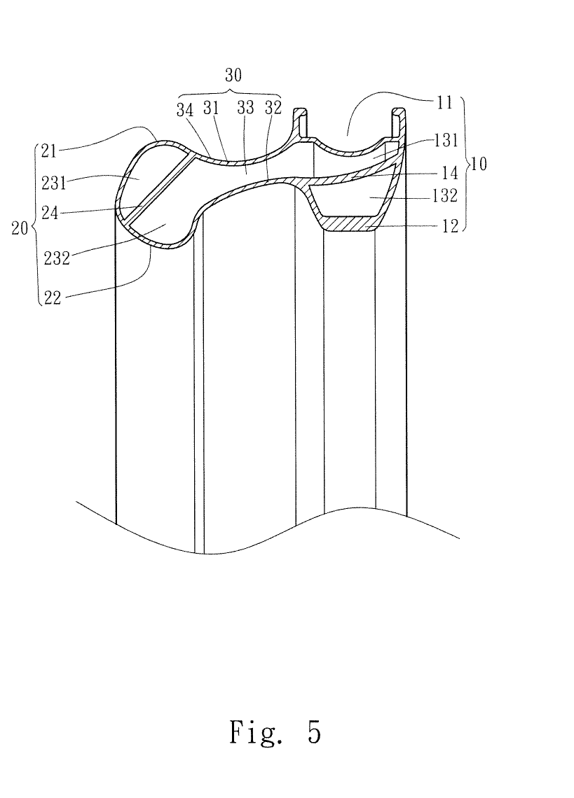

FIG. 5 shows the third embodiment, wherein a reinforcement rib 14 is located in the first hollow portion 13 and integrally connected to the inner periphery of the flange 12. The reinforcement rib 14 divides the first hollow portion 13 into two spaces 131, 132. A reinforcement rib 24 is located in the second hollow portion 23 and divides the second hollow portion 23 into two spaces 231, 232. The two reinforcement ribs 14, 24 can be made during manufacturing processes.

The two reinforcement ribs 14, 24 reinforce the strength of the wheel rim 10 and the hand rim 20.

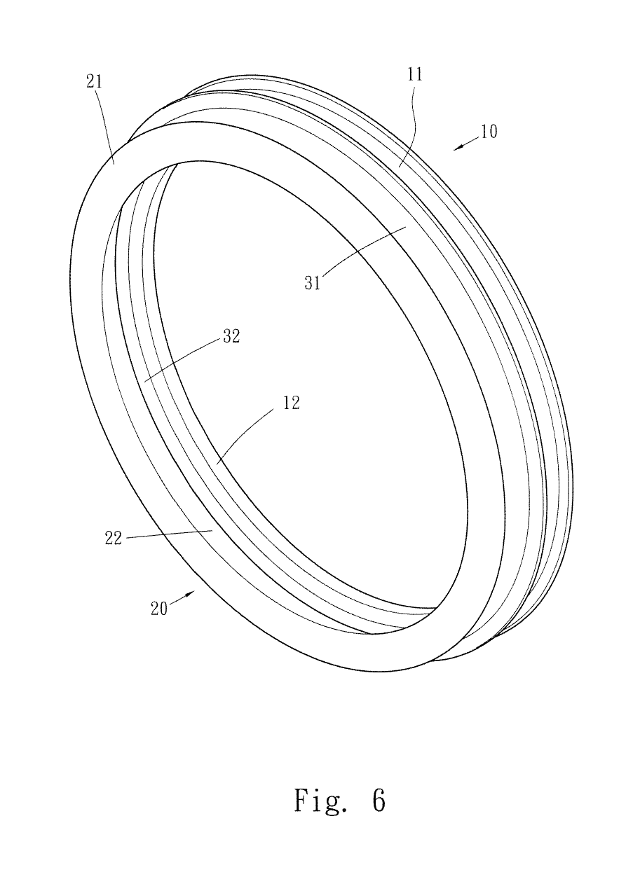

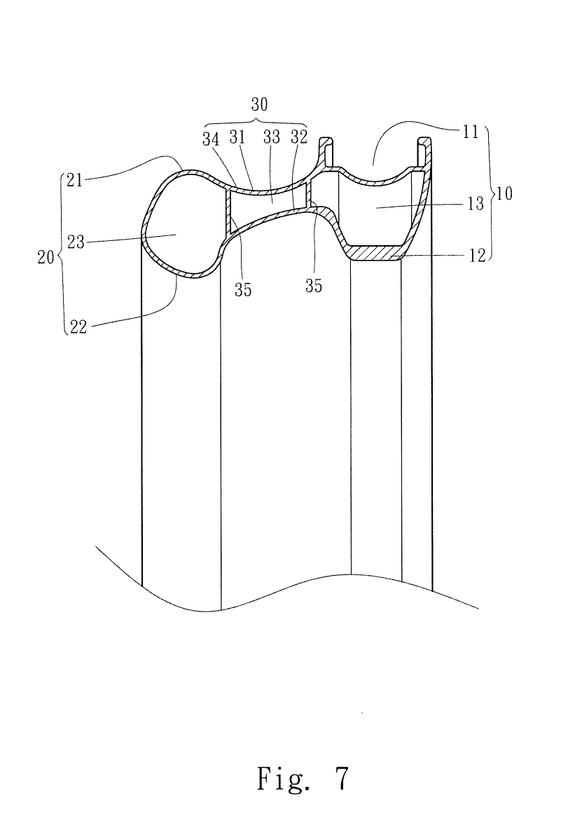

FIGS. 6 and 7 show the fourth embodiment, wherein two reinforcement ribs 35 are integrally and respectively connected between the inner and outer walls 31, 32. The reinforcement ribs 35 are located on two sides of the hollow rib 30 and separate the hollow area 33 and the first and second hollow portions 13, 23.

The two reinforcement ribs 35 reinforce the hollow rib 30. Although the first and second hollow portions 13, 23 do not communicate with the hollow area 33, the embodiment still have better shock-absorbing feature than the conventional wheel rim.

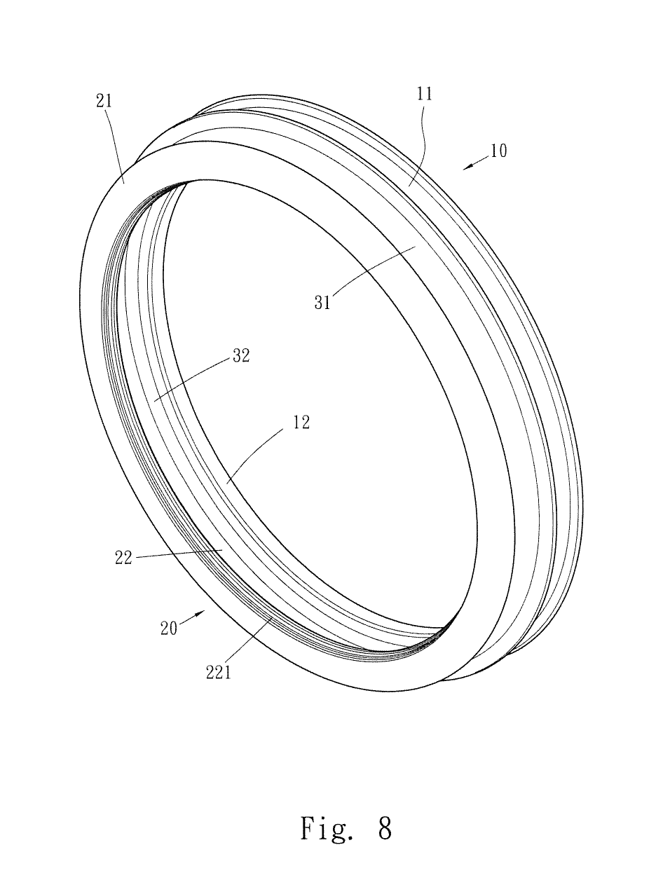

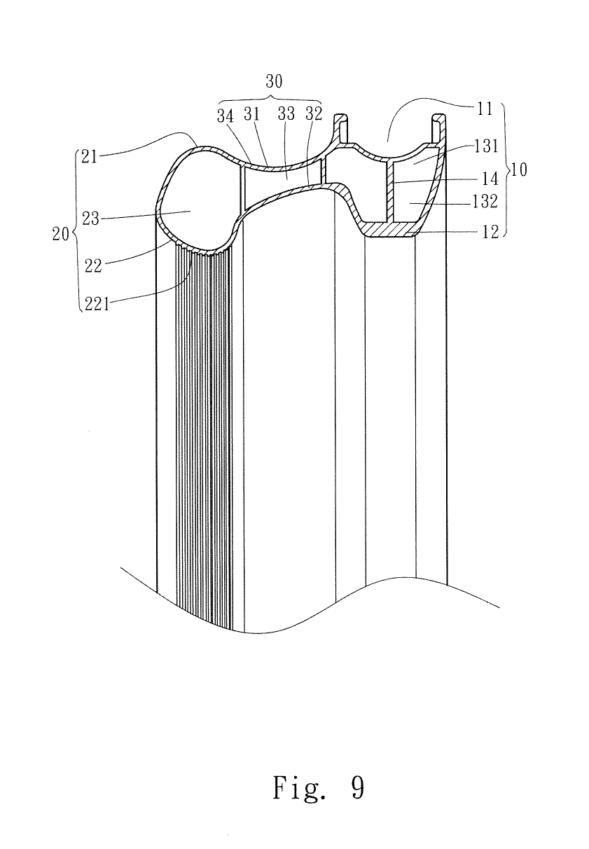

FIGS. 8 and 9 show the fifth embodiment, wherein a reinforcement rib 14 is connected in the first hollow portion 13 and divides the first hollow portion 13 into two spaces 131, 132. The reinforcement rib 14 is integrally connected to the inner periphery of the flange 12 and perpendicular to the flange 12. The finger portion 22 has a serrated anti-slip portion 221 which has multiple ridges on the outer periphery of the finger portion 22. The ridges, the reinforcement rib 14 and the anti-slip portion 221 are made during manufacturing processes.

The anti-slip portion 221 increase friction when the user holds the wheel rim 10 and the reinforcement rib 14 increases the strength of the wheel rim 10.

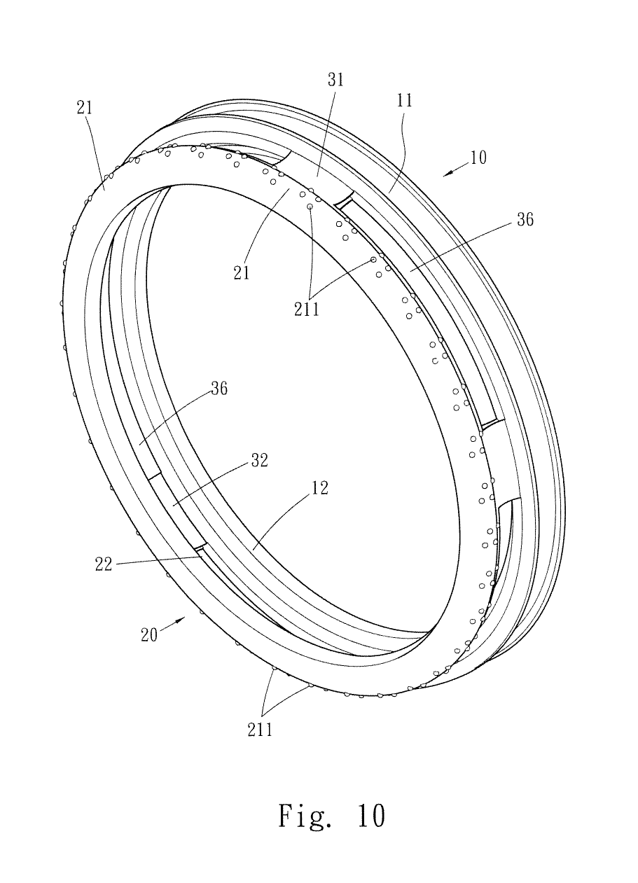

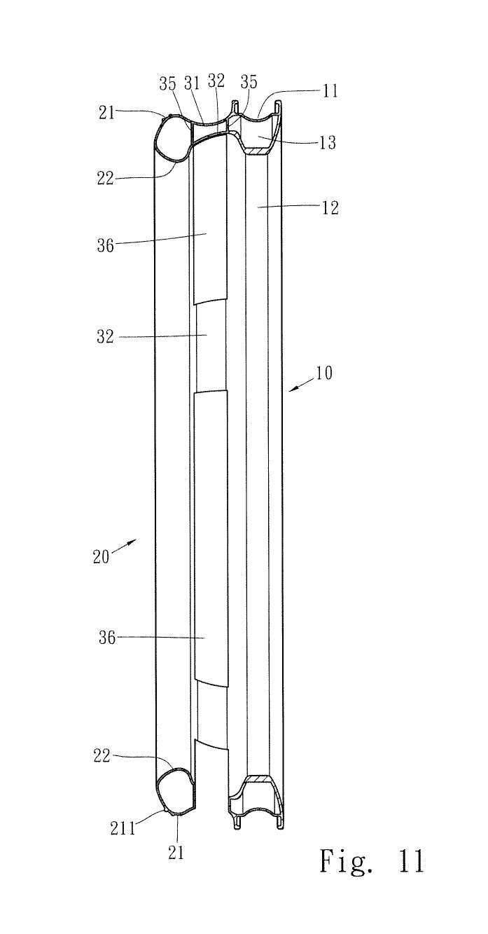

FIGS. 10 and 11 show the sixth embodiment, wherein the hollow rib 30 has multiple holes 36 defined through the inner and outer walls 32, 31. The palm portion 21 has another serrated anti-slip portion 211. The serrated anti-slip portion 211 comprises multiple bosses which are located on the outer periphery of the palm portion 21. The holes 36 are machined after the groove 11, the flange 12, the palm portion 21, the finger portion 22 and the inner and outer walls 32, 31 are made.

The anti-slip portion 211 increase friction when the user holds the wheel rim 10.

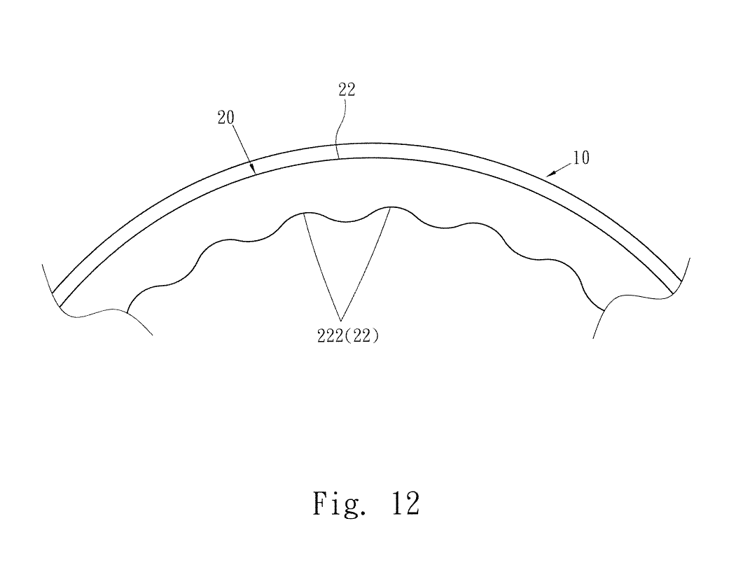

FIG. 12 shows the seventh embodiment, wherein the finger portion 22 has multiple curved recesses 222 defined in the outer periphery thereof and the curved recesses 222 can be made during the manufacturing processes.

The multiple curved recesses 222 are designed to accommodate the user's fingers which operate the wheel rim 10 in the tangential direction and the curved recesses 222 provide the fingers a support position to operate the wheel rim 10.

While we have shown and described the embodiment in accordance with the present invention, it should be clear to those skilled in the art that further embodiments may be made without departing from the scope of the present invention.

What is claimed is:

1. An integral wheel rim for a wheelchair comprising:
a wheel rim being a ring-shaped rim and a groove integrally defined in an outer periphery of the wheel rim, a tire engaged with the groove, a flange extending inward and radially from an inner periphery of the wheel rim and having a first hollow portion;
a hand rim located parallel to the wheel rim and integrally formed with the wheel rim, the hand rim being a ring-shaped rim and having a palm portion and a finger portion, the palm portion located on an outer periphery of the hand rim and the finger portion located on an inner periphery of the hand rim, the palm portion and the finger portion enclosing a second hollow portion, and
a hollow rib connected between the wheel rim and the hand rim, the hollow rib composed by an inner wall and an outer wall, the inner and outer walls being separated from each other, a hollow area defined between the inner and outer walls and communicating with the first and second hollow portions, the outer wall having a handle portion on an outer surface thereof for being touched by the user's hand

2. The wheel rim as claimed in claim 1, wherein the handle portion has a curved and recessed surface, the palm portion has a curved protruding surface, and the finger portion has a curved protruding surface.

3. The wheel rim as claimed in claim 1, wherein at least one reinforcement rib is integrally connected between the inner and outer walls, the at least one reinforcement rib divides the hollow area into at least two spaces.

4. The wheel rim as claimed in claim 1, wherein at least one reinforcement rib is located in the first hollow portion and integrally connected to an inner periphery of the flange, the at least one reinforcement rib divides the first hollow portion into at least two spaces.

5. The wheel rim as claimed in claim 1, wherein at least one reinforcement rib is located in the second hollow portion and integrally connected to an inner periphery of the hand rim, at least one reinforcement rib divides the second hollow portion into at least two spaces.

6. The wheel rim as claimed in claim 1, wherein the finger portion has a serrated anti-slip portion and the palm portion has another serrated anti-slip portion.

7. The wheel rim as claimed in claim 6, wherein the serrated anti-slip portion comprises multiple ridges which are located on an outer periphery of the finger portion.

8. The wheel rim as claimed in claim 6, wherein the serrated anti-slip portion comprises multiple bosses which are located on an outer periphery of the palm portion.

9. The wheel rim as claimed in claim 1, wherein the hollow rib has multiple holes defined through the inner and outer walls.

10. The wheel rim as claimed in claim 1, wherein the finger portion has multiple curved recesses defined in an outer periphery thereof.
